(19) United States
(12) Patent Application Publication
(10) Pub. No.: US 2010/0310764 A1
(43) Pub. Date: Dec. 9, 2010

(54) METHOD OF PROTECTING A CMC MATERIAL THERMOSTRUCTURAL PART MADE OF CERAMIC MATRIX COMPOSITE MATERIAL AGAINST WEAR, A COATING, AND A PART OBTAINED BY THE METHOD

(75) Inventors: Thibault Marie-Jacques Arnold, Fontainebleau (FR); Joel Michael Daniel Benoit, Cesson La Foret (FR); Arnaud Biramben, Paris (FR); Christian Marty, Boulogne (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SNECMA, Paris (FR)

(21) Appl. No.: 11/536,349

(22) Filed: Sep. 28, 2006

(30) Foreign Application Priority Data
Sep. 28, 2005 (FR) 0509880

(51) Int. Cl. B05D 3/10; B32B 18/00; B05B 12/00

(52) U.S. Cl. 427/193; 428/698; 239/265.33

(57) ABSTRACT

A method of protecting a thermostructural part made of ceramic matrix composite material against wear by coating the part is disclosed. The coating is made by
providing a mixture comprising colloidal silica, a powdered silico-aluminous and/or aluminous refractory ceramic material, and water; applying at least one layer of the mixture on the part; drying the layer; and placing the part at a temperature greater than 1000° C., thereby firing the layer and forming an enamel coating. The invention is applicable to SiC moving flaps for a turbojet nozzle.

The invention relates to a method of protecting a thermostructural part made of ceramic matrix composite material against wear, to a protective coating, and to a part obtained by the method.

### BACKGROUND OF THE INVENTION

Thermostructural composite materials are characterized by mechanical properties that make them suitable for constituting structural parts, while also conserving these mechanical properties at high temperatures. They are constituted by fiber reinforcement densified by a matrix of refractory material that fills in the pores of the fiber material, at least in part. The materials selected for the fibers and the matrix are typically taken from carbon and ceramics.

Mention can be made of the following examples of thermostructural composite materials: carbon/carbon (C/C) composites and ceramic matrix composites (CMCs) such as C/SiC or SiC/SiC (carbon fiber or SiC reinforcement with a silicon carbide matrix), or C/C—SiC (carbon fiber reinforcement and a matrix comprising a mixture of carbon and silicon carbide), or C/SiB-C (carbon fiber reinforcement and self-healing matrix), or indeed C/C—SiC—Si (a C/C composite silicided by reaction with Si).

The invention relates to making protective coatings for improving the resistance to wear due to friction and high temperature (in the range 500° C. to 1000° C. or higher) of ceramic matrix composite (CMC) materials, in particular those including silicon carbide.

In particular, it is found that such CMC materials present resistance to wear by friction at high temperature that is limiting in certain applications, in particular as a primary moving flap (driven or follower) in a turbojet exhaust nozzle.

Attempts at modifying CMC materials, by changing the composition of the matrix and/or the fibers or the structure of the material have not led to sufficient improvement.

### OBJECTS AND SUMMARY OF THE INVENTION

An object of the present invention is to provide a method of protecting a CMC material thermostructural part against wear that enables the drawbacks of the prior art to be overcome, and in particular that provide high effectiveness.

According to the present invention, this object is achieved by a method wherein a coating is made by the following steps:

a) providing a mixture comprising colloidal silica, a powdered silico-aluminous and/or aluminous refractory ceramic material, and water;

b) applying at least one layer of the mixture on the part;

c) drying the layer; and

d) placing the part at a temperature greater than 1000° C., thereby firing the layer and forming an enamel coating.

It can thus be understood that merely by applying an aqueous-based mixture, drying it, and firing it at high temperature, an enamel coating is made that provides protection against friction wear at high temperature.

This solution also presents the additional advantage of being very simple to implement and of being capable of being industrialized at low cost.

In addition, it is found that the method of the invention makes it possible to provide a coating that not only withstands friction wear at high temperature, but also a coating that can be used for modifying the emissivity characteristics of the coated zone by adding additives and/or fillers selected for this purpose. For example, if the deposit is made on the inside surfaces of the flaps (the surface facing the axis), it can be decided to use fillers that increase emissivity in order to reduce the reflections coming from the internal portion of the engine. Alternatively, or in addition, if the deposit is made on the outside surfaces of the flaps, it can be decided to use fillers that reduce emissivity and apparent temperature, likewise for the purpose of reducing the infrared signature of the jet.

Overall, because of the solution of the present invention, it is possible to provide an enamel-type coating on any CMC part for the purpose of reinforcing its properties of withstanding friction wear at high temperature.

In particular, significantly improved results are obtained when the mixture is applied on a surface layer of the part, when said surface layer comprises silicon carbide (SiC) and/or boron carbide (BC).

It should be observed that depending on the intended application, the mixture may be applied on all or by a portion of the outside surface of the part. For example, for the diverging portion of a thruster nozzle, the mixture may be applied solely to the surfaces subjected to friction, and in particular solely on the outside surfaces or the inside surfaces of moving flaps of the diverging portion.

In the mixture, the refractory ceramic material preferably belongs to the family comprising alumina silicates (in particular mullite, but also silimanite), aluminum silicates (e.g. cyanite), and alumina.

The refractory ceramic material is preferably mullite, and the mixture also contains orthophosphoric acid P₂O₅.

Advantageously, the layer presents a thickness of about 200 micrometers (μm), after drying.

The method of the invention preferably also includes, before step d), a step of grinding with an abrasive medium containing boron nitride, in order to achieve a surface that is smooth and improve sliding on the surface of the coating.

The present invention also provides a coating for protecting a CMC material thermostructural part against wear, the coating being made using the above-described method.

In particular, the present invention also provides a coating for protecting a CMC material thermostructural part against wear, the coating forming an enamel containing silico-aluminous and/or aluminous refractory materials.

The present invention also provides a CMC material thermostructural part including a protective coating against wear constituted by enamel containing silico-aluminous and/or aluminous refractory materials.

In either of the two above circumstances, the surface layer of the part situated under the coating preferably comprises silicon carbide (SIC) and/or boron carbide (BC).

For example, the part of the present invention may constitute a moving flap for an exhaust for a turbojet exhaust nozzle of section that is variable by throttling, the flap having at least a portion of its surface (outside and/or inside surface) provided with a protective coating against wear.

### BRIEF DESCRIPTION OF THE DRAWING

Other advantages and characteristics of the invention appear on reading the following description made in non-limiting manner and with reference to an implementation and with reference to the accompanying drawing, in which:

FIG. 1 is a fragmentary view of a turbojet seen in projection from behind; and

FIG. 2 shows the results of a wear test.

### MORE DETAILED DESCRIPTION

### Implementation

A mixture was made of the following ingredients:
colloidal silica having a specific surface area of 200 square meters per gram (m²/g) to 300 m²/g;
mullite (2 SiO₂, 3 Al₂O₃) in the form of particles having a diameter <40 μm;
water; and
orthophosphoric acid P₂O₅.

The ingredients were mixed so as to obtain a uniform suspension which was screened at 50 micrometers to eliminate lumps or clots.

A mixture was obtained having proportions giving the mullite type coating composition of Table 1 below.

TABLE 1

| Coating | Composition (% by weight) | | | |
|---|---|---|---|---|
| type | SiO₂ | Al₂O₃ | H₂O | P₂O₅ |
| Mullite | 33.5 (±10%) | 31.5 (±10%) | 27.3 (±10%) | 7.7 (±10%) |
| Margot | 33.8 (±10%) | 44 (±10%) | 22.2 (±10%) | — |
| Alumina | 20 (±10%) | 50 (±10%) | 30 (±10%) | — |

The mixture forms an aqueous solution that can be deposited as one or more layers in numerous ways: spray gun, paint brush, or indeed using a pad and/or by immersion (dipping).

The mixture should be applied quite quickly after being prepared (within 10 minutes (min) to 15 min after the beginning of preparation), since the mixture thickens over time.

Spraying was performed using a spray gun with its nozzle spraying at a distance of 25 millimeters (mm) to 35 mm from the part, using a pressure of 2 bars.

A good thickness for the specific application to CMC nozzle flaps is 200 micrometers (thickness after drying), applied in one or two layers. Excess thickness leads to cracking, while insufficient thickness fails to hide the roughness of the material constituting the part.

At this stage, it should be observed that a deposit that presents deficiencies can be removed merely by washing, and after drying, it is possible to apply a new layer.

Furthermore, it is preferable to apply two (or more) fine layers of the mixture, with an intermediate drying step, rather than applying the mixture as a single thick layer prior to performing a drying operation, since this serves to avoid risks of the coating cracking.

Once the deposit has been applied to the part, it is dried in a stove at 60° C. for 30 min.

During drying, the particles move towards one another and the mixture forms a kind of mortar in which the silica is the granular filler and the mullite is the cement.

After drying, the deposit is surfaced and burnished using an abrasive paper coated in boron nitride: this serves to make the thickness of the deposit more uniform by striking off its surface so as to improve the sliding qualities of the coating (it is also possible to use a different nitride such as aluminum nitride or silicon nitride).

The surface is thus smoother before being fired, which consists in placing the part directly in a kiln at more than 1000° C. (in particular at 1100° C.) for a period of 5 min to 15 min, depending on the mass of the part.

Those steps have been performed over the entire surface of two parts in order to perform a wear resistance test: a plate forming a track having dimensions of 40 mm by 50 mm, and a peg having a length of 30 mm and a width of 8 mm.

The wear resistance test consisted in holding the peg stationary with the track in contact with its end and being subjected to reciprocating rectilinear movement in translation.

FIG. 2 gives the wear results for completely identical test conditions on a standard CMC material (specifically C/SiC) and the same material covered in a mullite type coating.

This chart is in the form of a histogram and is normalized on the basis of the wear suffered by the track of the standard CMC material, used as a reference.

From these results, it can be seen that track wear was reduced significantly, and in particular to less than half, when the wear test was performed with the addition of a protective coating against wear. Peg wear was also smaller in the presence of the coating: this relatively small difference can also be explained by the test conditions.

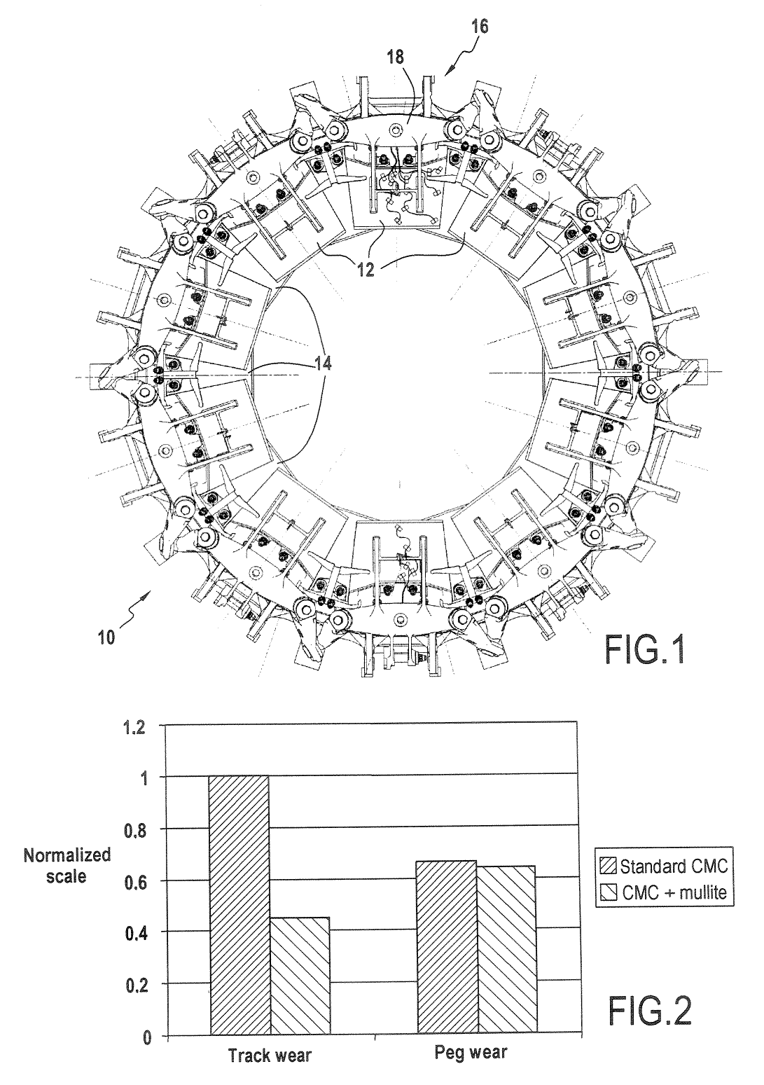

To illustrate one possible application of the method of the invention for providing protection against wear, reference can be made to FIG. 1 in which there can be seen a nozzle 10 shown in its most tightly-closed position, forming a converging cone.

The nozzle 10 essentially comprises driven flaps 12 and follower flaps 14 that are set into movement by a control system 16 comprising in particular control levers 18.

In particular, the nozzle 10 shown in FIG. 1 may comprise driven flaps 12 made of CMC material and follower flaps 14 made of metal: under such circumstances, wear is observed most particularly on the surfaces of the driven flaps 12 that come into friction contact with the metal follower flaps 14.

However, the nozzle 10 could equally well have driven flaps 12 and follower flaps 14 all made of CMC material.

If the jet engine has an after-burner, the flaps are located at the outlet of the primary flow in a hot stream at a temperature lying in the range 700° C. to 950° C.

Under such circumstances, a protective coating of the invention against wear is made in the manner described above, either over the entire surface area of both types of flap 12 and 14, or solely over the inside surfaces of the driven flaps 12 and the outside surfaces of the follower flaps 14, or indeed solely on those zones of said surfaces that come into contact with one another in the various possible positions.

The refractory material is naturally selected so as to present a coefficient of expansion that is substantially identical to that of the ceramic matrix composite material of the part on which the coating is made.

When the part for protection is made of a C/C composite, the mixture can be applied on the part directly, or after a refractory undercoat has been formed, in particular an SiC undercoat.

Naturally, the present invention is not limited to nozzle flaps, but can be applied to any CMC material thermostructural part, in particular comprising SIC, that is liable to be subjected to wear by friction over all or part of its surface: in particular, the invention applies to the walls of combustion chambers, casings, after-burner arms, . . . .

1. A method of protecting a thermostructural part against wear, the method comprising:
coating said thermostructural part,
wherein the coating is made by the following steps:
a) providing a mixture comprising (i) colloidal silica, (ii) at least one of a powdered silico-aluminous or aluminous refractory ceramic material, and (iii) water;
b) applying at least one layer of the mixture on the part;
c) drying the layer in a stove;
d) grinding the dried layer with an abrasive medium containing boron nitride; and
e) placing the part at a temperature greater than 1000° C., thereby firing the layer and forming an enamel coating,
said coating having a thickness of about 200 μm and
wherein said thermostructural part includes a ceramic matrix composite material constituted by fiber reinforcements densified by a matrix of refractory material that fills in pores of the fiber reinforcements.

2. A method according to claim 1, wherein the mixture is applied on a surface layer of the part that comprises at least one of silicon carbide or boron carbide.

3. A method according to claim 1, wherein the refractory ceramic material in the mixture belongs to the family comprising alumina silicates, aluminum silicates, and alumina.

4. A method according to claim 1, wherein the refractory ceramic material in the mixture is mullite.

5. A method according to claim 1, wherein the mixture also includes orthophosphoric acid.

6. (canceled)

7. A protective coating against wear for a thermostructural part made of ceramic matrix composite material, the coating being made according to the method of claim 1.

8. A protective coating against wear for a thermostructural part made of ceramic matrix composite material, said coating forming an enamel containing silico-aluminous and/or aluminous refractory materials, and having a thickness of about 200 μm.

9. A coating according to claim 8, wherein the surface layer of the part situated under the coating comprises silicon carbide and/or boron carbide.

10. A thermostructural part made of ceramic matrix composite material, the part including a protective coating against wear constituted by an enamel containing silico-aluminous and/or aluminous refractory materials, said coating having a thickness of about 200 μm.

11. A part according to claim 10, including, under the coating, a surface layer comprising silicon carbide and/or boron carbide.

12. A part according to claim 10, constituting a moving flap of a turbojet exhaust nozzle of section that is variable by throttling, the flap having at least a portion of its outside surface provided with a protective coating against wear.

13. A nozzle including a part according to claim 12.

14. A turbojet including a part according to claim 12.

15. A method according to claim 1, further comprising, prior to the grinding, applying another layer of the mixture on the dried layer; and
drying the another layer.
